(19) United States
(12) Patent Application Publication
(10) Pub. No.: US 2024/0413903 A1
(43) Pub. Date: Dec. 12, 2024

(54) COMMUNICATION SYSTEM, COMMUNICATION METHOD AND PROGRAM

(71) Applicants: Takafumi TANAKA, Musashino-shi, Tokyo (JP); Shingo KAWAI, Musashino-shi, Tokyo (JP); Tetsuro INUI, Musashino-shi, Tokyo (JP)

(72) Inventors: Takafumi TANAKA, Musashino-shi, Tokyo (JP); Shingo KAWAI, Musashino-shi, Tokyo (JP); Tetsuro INUI, Musashino-shi, Tokyo (JP)

(21) Appl. No.: 18/697,638

(22) PCT Filed: Oct. 6, 2021
(86) PCT No.: PCT/JP2021/036920

§ 371 Date: Apr. 1, 2024

(51) Int. Cl. H04B 10/079

(52) U.S. Cl. CPC H04B 10/07953

(57) ABSTRACT

An aspect of the present invention is a communication system including a branching unit configured to branch an optical signal transmitted by a transmitter that transmits an optical signal, and a learning unit configured to update an estimation model, which is a mathematical model for estimating a state of a host system on the basis of information indicating an object characteristic that is a predetermined characteristic of the optical signal, on the basis of one of optical signals branched by the branching unit.

### TECHNICAL FIELD

The present invention relates to a communication system, a communication method, and a program.

### BACKGROUND ART

In recent years, attempts have been made to apply machine learning and deep learning techniques to digital modulation signals obtained by a receiver of a digital coherent optical transceiver to monitor transmission characteristics of optical fiber communication and detect abnormality occurrence.

For example, NPL 1 proposes to use a neural network with a constellation of digital modulation signals obtained by a receiver of a digital coherent optical transceiver visualized by a two-dimensional plot of real/imaginary axes as input parameters. More specifically, a method of using such a neural network to identify distortion of a constellation caused by state changes due to bending, pressure, or the like applied to an optical fiber has been proposed.

In addition, there have also been attempts to use a neural network that has learned the shape of a constellation to monitor transmission characteristics. For example, NPL 2 shows that by making a neural network learn feature amounts calculated from a constellation, it is possible to estimate quantities representing transmission characteristics such as unknown wavelength dispersion and an optical signal-to-noise ratio.

Here, an example of learning and estimation using a neural network for the purpose of estimating an optical signal-to-noise ratio (OSNR) and polarization mode dispersion (PMD) at a receiver of a digital coherent optical transceiver will be described with reference to FIG. 16.

In learning of such a neural network, a constellation with known OSNR and PMD is input to the neural network. In such learning, a process of tuning weights of the neural network on the basis of the output result of the neural network and the OSNR and PMD in the input constellation is repeated. As a result, the neural network learns regularity for each label. A label means a set of OSNR and PMD.

When an unknown unlabeled constellation is input to a trained neural network, the neural network outputs the most appropriate label on the basis of past regularity.

Thus, it is necessary to prepare data (that is, constellation) and labels (that is, a set of OSNR and PMD) for learning of the neural network.

FIG. 17 shows a general system for acquiring a dataset which is a combination of data and labels. The system of FIG. 17 includes an emulation unit that can arbitrarily change the transmission characteristics for an optical transmission line between optical nodes to be measured in accordance with parameters desired to be learned.

In the system of FIG. 17, a constellation is acquired from an optical receiver, learning of the neural network is performed in an optical transmission line state learning unit, and an obtained model is used for estimation.

### CITATION LIST

### Non Patent Literature

[NPL 1] T. Tanaka, S. Kuwabara, H. Nishizawa, T. Inui, S. Kobayashi, A. Hirano, “Field demonstration of real-time optical network diagnosis using deep neural network and telemetry,” OFC2019, Tu2E.5.
[NPL 2] J. A. Jargon, X. Wu, H. Y. Choi, Y. Chung, and A. E. Willner, “Optical performance monitoring of QPSK data channels by use of neural networks trained with parameters derived from asynchronous constellation diagrams,” Optics Express vol. 18, No. 5, March 2010.

### SUMMARY OF INVENTION

### Technical Problem

However, in an actual optical network operating environment, it is difficult to arbitrarily change transmission characteristics for a transmission line because of influence on service quality. In addition, as another method, a method of acquiring data with changed transmission characteristics before the start of data transmission and reception can also be considered, but it takes time to acquire the data.

Further, in any method, only estimation using a trained model can be performed after the service has started, and learning data cannot be acquired. In this case, even if laser characteristics change due to, for example, deterioration over time, only a model prepared at the start of operation can be used, so there is a possibility of deterioration in the accuracy of estimation occurring.

As described above, it is difficult to detect the state of optical fiber communication such as transmission characteristic monitoring and abnormality occurrence detection in optical fiber communication after the start of service, and the burden required to manage optical fiber communication has increased in some cases. In addition, this has been a problem common to communication systems without being limited to optical fiber communication.

In view of the above circumstances, an object of the present invention is to provide a technique of reducing the burden required to manage a communication system.

### Solution to Problem

According to an aspect of the present invention, there is provided a communication system including: a branching unit configured to branch an optical signal transmitted by a transmitter that transmits an optical signal; and a learning unit configured to update an estimation model, which is a mathematical model for estimating a state of a host system on the basis of information indicating an object characteristic that is a predetermined characteristic of the optical signal, on the basis of one of optical signals branched by the branching unit.

According to an aspect of the present invention, there is provided a communication method which is executed by a communication system including a branching unit configured to branch an optical signal transmitted by a transmitter that transmits an optical signal, and a learning unit configured to update an estimation model, which is a mathematical model for estimating a state of a host system on the basis of an object characteristic that is a predetermined characteristic of the optical signal, on the basis of one of optical signals branched by the branching unit, the method including a learning step of updating the estimation model on the basis of one of optical signals branched by the branching unit.

According to an aspect of the present invention, there is provided a program for causing a computer to function as the above communication system.

### Advantageous Effects of Invention

According to the present invention, it is possible to reduce the burden required to manage a communication system.

### BRIEF DESCRIPTION OF DRAWINGS

FIG. 1 is a diagram illustrating an example of a configuration of a communication system in an embodiment.

FIG. 2 is a diagram illustrating an example of a hardware configuration of an emulation unit in the embodiment.

FIG. 3 is a diagram illustrating an example of a hardware configuration of an optical signal receiving unit in the embodiment.

FIG. 4 is a diagram illustrating an example of a hardware configuration of a state learning unit in the embodiment.

FIG. 5 is a diagram illustrating an example of a configuration of a control unit included in the state learning unit in the embodiment.

FIG. 6 is a diagram illustrating an example of a hardware configuration of an optical receiver in the embodiment.

FIG. 7 is a diagram illustrating an example of a hardware configuration of an estimation unit in the embodiment.

FIG. 8 is a diagram illustrating an example of a configuration of a control unit included in the estimation unit in the embodiment.

FIG. 9 is a diagram illustrating an example of object characteristic information included in training data in the embodiment.

FIG. 10 is a flowchart illustrating an example a flow of processing executed by a learning device in the embodiment.

FIG. 11 is a flowchart illustrating an example of a flow of processing executed by a reception-side optical node device in the embodiment.

FIG. 12 is a first flowchart illustrating an example of a flow of processing executed by the communication system in the embodiment.

FIG. 13 is a second flowchart illustrating an example of a flow of processing executed by the communication system in the embodiment.

FIG. 14 is a diagram illustrating an example of a configuration of a communication system in a modification example.

FIG. 15 is a diagram illustrating an example of a hardware configuration of an optical signal selection unit in the modification example.

FIG. 16 is a first diagram illustrating a related art.

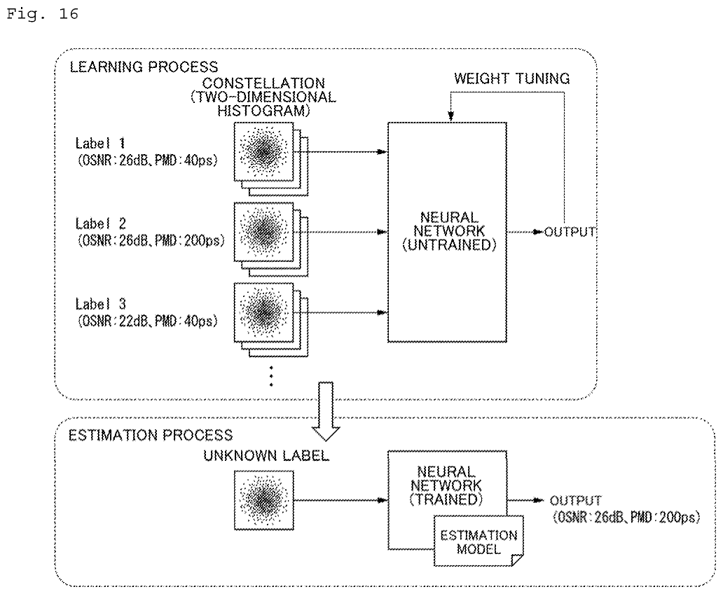

FIG. 17 is a second diagram illustrating a related art.

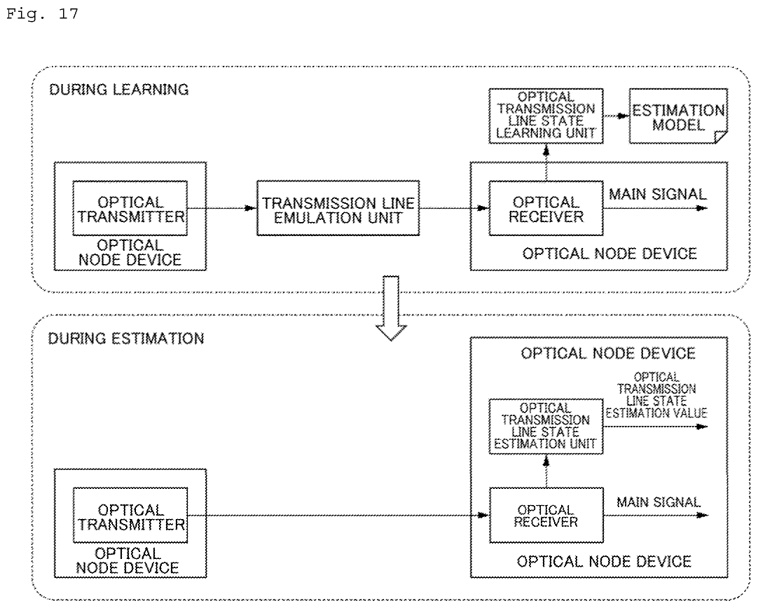

### DESCRIPTION OF EMBODIMENTS

### Embodiment

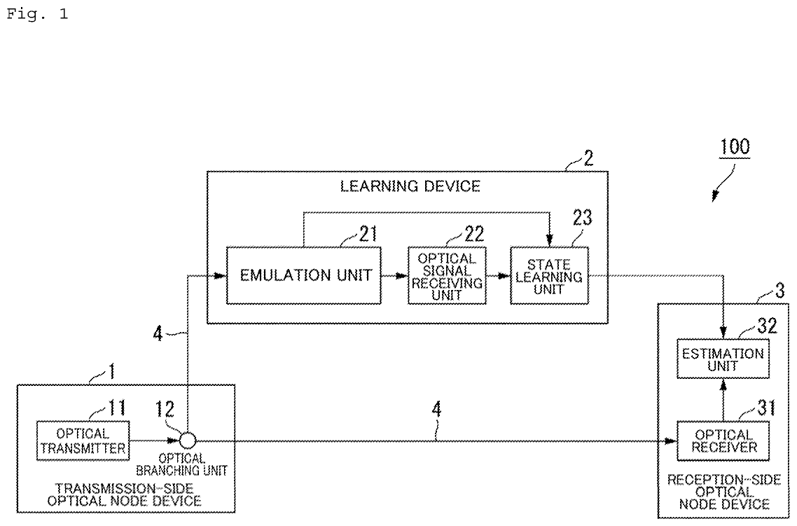

FIG. 1 is a diagram illustrating an example of a configuration of a communication system 100 in an embodiment. The communication system 100 is a communication system that achieves both communication and a reduction in the burden required to manage a host device. The communication system 100 is, for example, a communication system that performs optical fiber communication. The communication system 100 includes a transmission-side optical node device 1, a learning device 2, and a reception-side optical node device 3.

The transmission-side optical node device 1 transmits an optical signal. The learning device 2 receives an optical signal and updates a mathematical model for estimating the state of the communication system 100 through learning on the basis of the received optical signal. The reception-side optical node device 3 receives an optical signal. In addition, the reception-side optical node device 3 uses the mathematical model obtained by the learning device 2 to estimate the state of the communication system 100.

Meanwhile, the mathematical model is a set including one or a plurality of processes whose execution conditions and order (hereinafter referred to as “execution rules”) are determined in advance. Learning means updating the mathematical model using a machine learning method. Updating the mathematical model means appropriately adjusting the values of parameters in the mathematical model. In addition, execution of the mathematical model means executing each process included in the mathematical model in accordance with the execution rules.

The mathematical model is updated through learning until a predetermined termination condition related to learning (hereinafter referred to as a “learning termination condition”) is satisfied. The learning termination condition is, for example, that learning has been performed a predetermined number of times.

The transmission-side optical node device 1 and the learning device 2 are connected to each other through an optical fiber 4, and an optical signal propagates from the transmission-side optical node device 1 to the learning device 2 through the optical fiber 4. The transmission-side optical node device 1 and the reception-side optical node device 3 are connected to through the optical fiber 4, and an optical signal propagates from the transmission-side optical node device 1 to the reception-side optical node device 3 through the optical fiber 4. The optical fiber 4 is a transmission line (that is, an optical fiber) through an optical signal propagates.

The transmission-side optical node device 1 includes an optical transmitter 11 and an optical branching unit 12. The optical transmitter 11 transmits an optical signal. The optical branching unit 12 branches an optical signal. The optical branching unit 12 is, for example, an optical coupler.

The learning device 2 receives the optical signal branched by the optical branching unit 12. More specifically, the learning device 2 receives one of a plurality of optical signals branched by the optical branching unit 12. The learning device 2 includes an emulation unit 21, an optical signal receiving unit 22, and a state learning unit 23.

### <Emulation Unit 21>

The emulation unit 21 changes the characteristics of the received optical signal. That is, the emulation unit 21 is a functional unit that simulates a change that can occur in the optical signal due to an event occurring within the communication system 100 to the received optical signal. The change in the characteristics of the optical signal by the emulation unit 21 is not the same for all optical signals. It is desirable that the change in characteristics be as close to random as possible. The change in the characteristics of the optical signal by the emulation unit 21 may be a change that satisfies a condition instructed by a user.

In this way, the emulation unit 21 generates a plurality of types of optical signals. Information indicating the characteristics of the optical signal generated by the emulation unit 21 is used for learning of a mathematical model as will be described later. Therefore, the learning device 2 can perform learning using information indicating the characteristics of a plurality of types of optical signals.

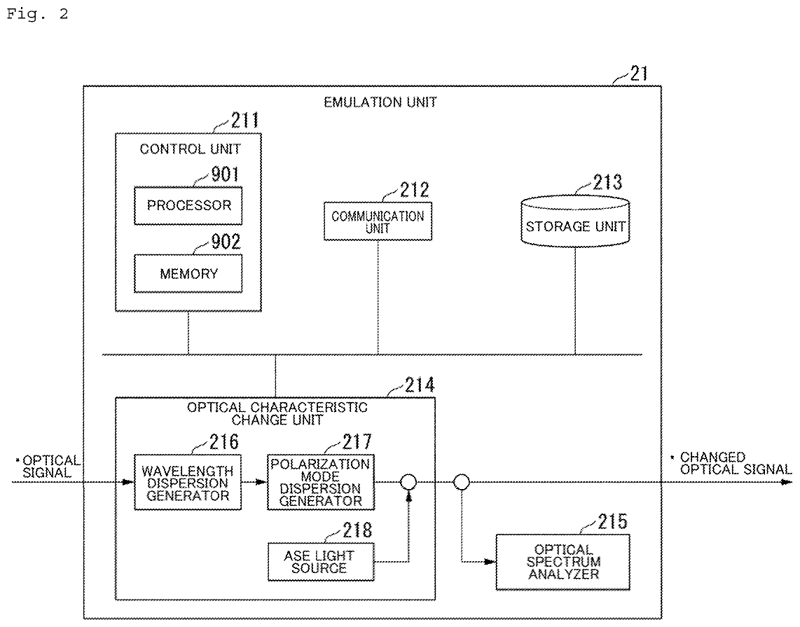

FIG. 2 is a diagram illustrating an example of a hardware configuration of the emulation unit 21 in the embodiment. The emulation unit 21 includes a control unit 211 including a processor 91 such as a central processing unit (CPU) connected through a bus and a memory 92, and execute a program. The emulation unit 21 functions as a device including the control unit 211, a communication unit 212, a storage unit 213, an optical characteristic change unit 214, and an optical spectrum analyzer 215 by executing a program.

More specifically, the processor 91 reads out a program stored in the storage unit 213 and causes the memory 92 to store the readout program. By the processor 91 executing the program stored in the memory 92, the emulation unit 21 functions as a device including the control unit 211, the communication unit 212, the storage unit 213, the optical characteristic change unit 214, and the optical spectrum analyzer 215.

The control unit 211 controls operations of various functional units included in the emulation unit 21. The control unit 211 controls, for example, the operation of the optical characteristic change unit 214. The control unit 211 controls, for example, the operation of the optical spectrum analyzer 215 to acquire the analysis result of an optical spectrogram analyzer. The control unit 211 records, for example, various types of information in the storage unit 213.

The communication unit 212 is configured to include a communication interface for connecting the emulation unit 21 to an external device. The communication unit 212 communicates with an external device through wired or wireless connection. The external device is, for example, the state learning unit 23. The communication unit 212 transmits information indicating the content of the change made by the optical characteristic change unit 214 (hereinafter referred to as “change content information”) to the state learning unit 23. In addition, the communication unit 212 may be communicably connected to a computer operated by a user and may accept a user's operation on the emulation unit 21.

The storage unit 213 is configured using a computer readable storage medium device such as a magnetic hard disk device or a semiconductor storage device. The storage unit 213 stores various types of information on the emulation unit 21. The storage unit 213 may store, for example, the change content information.

The optical signal branched by the optical branching unit 12 is incident on the optical characteristic change unit 214. That is, the reception of the optical signal by the learning device 2 means the reception of the optical signal by the optical characteristic change unit 214.

The optical characteristic change unit 214 changes the characteristics of the optical signal. The characteristics may be, for example, wavelength dispersion, polarization mode dispersion, or a signal-to-noise ratio. In the example of FIG. 2, the optical characteristic change unit 214 includes a wavelength dispersion generator 216, a polarization mode dispersion generator 217, and an amplified spontaneous emission (ASE) light source 218. The wavelength dispersion generator 216 changes wavelength dispersion. The polarization mode dispersion generator 217 changes polarization mode dispersion (PMD). The ASE light source 218 imparts noise to a signal.

Meanwhile, the configuration of the optical characteristic change unit 214 in FIG. 2 is an example, and the optical characteristic change unit 214 may have any configuration insofar as it can change the desired characteristics of the optical signal. Therefore, the optical characteristic change unit 214 may include, for example, only one of the wavelength dispersion generator 216, the polarization mode dispersion generator 217, or the ASE light source 218, or may include only two of them. In addition, the optical characteristic change unit 214 may include, for example, a device that changes the characteristics of the optical signal other than the wavelength dispersion generator 216, the polarization mode dispersion generator 217, and the ASE light source 218.

The emulation unit 21 outputs the optical signal converted by the optical characteristic change unit 214.

The control unit 211 acquires information indicating how the optical characteristic change unit 214 has converted the optical signal from the optical characteristic change unit 214. The information indicating how the optical characteristic change unit 214 has converted the optical signal is change content information.

More specifically, the control unit 211 acquires information indicating how each functional unit included in the optical characteristic change unit 214 such as the wavelength dispersion generator 216, the polarization mode dispersion generator 217, or the ASE light source 218 has converted the optical signal from each functional unit included in the optical characteristic change unit 214. The acquired change content information is used for learning of the mathematical model in the state learning unit 23 of which the details will be described later.

The optical spectrum analyzer 215 analyzes the characteristics of the optical signal changed by the optical characteristic change unit 214.

### <Optical Signal Receiving Unit 22>

The optical signal receiving unit 22 receives the optical signal output by the emulation unit 21 and performs A/D conversion on the received optical signal. The A/D conversion means a process of converting an analog signal into a digital signal. The optical signal receiving unit 22 is, for example, an analog-to-digital converter. The optical signal receiving unit 22 outputs an optical signal after A/D conversion.

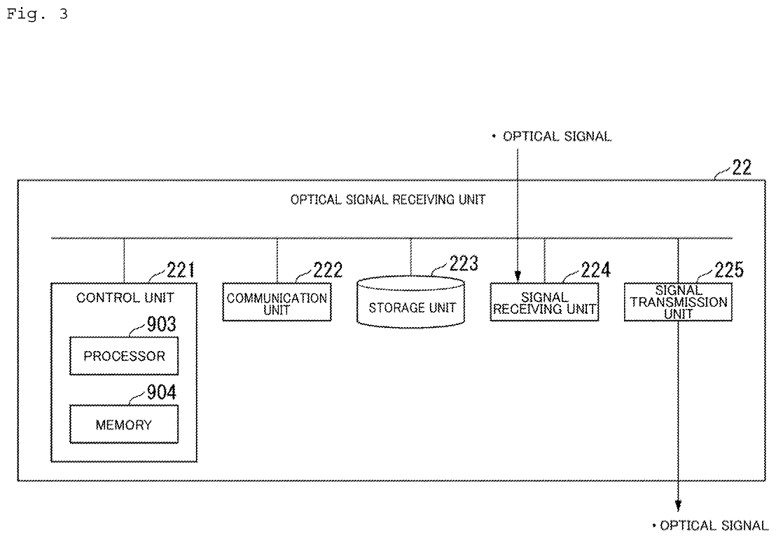

FIG. 3 is a diagram illustrating an example of a hardware configuration of the optical signal receiving unit 22 in the embodiment. The optical signal receiving unit 22 includes a control unit 221 including a processor 903 such as a CPU connected through a bus and a memory 904, and executes a program. The optical signal receiving unit 22 functions as a device including the control unit 221, a communication unit 222, a storage unit 223, a signal receiving unit 224, and a signal transmission unit 225 by executing a program.

More specifically, the processor 903 reads out a program stored in a storage unit 233 and causes the memory 904 to store the readout program. By the processor 903 executing the program stored in the memory 904, the optical signal receiving unit 22 functions as a device including the control unit 221, the communication unit 222, the storage unit 223, the signal receiving unit 224, and the signal transmission unit 225.

The control unit 221 controls operations of various functional units included in the optical signal receiving unit 22. The control unit 221 records, for example, various types of information in the storage unit 223. The control unit 221 executes, for example, A/D conversion on the optical signal received by the signal receiving unit 224. The control unit 221 causes the signal transmission unit 225 to transmit, for example, the optical signal after A/D conversion. Meanwhile, the control unit 221 may execute signal processing other than A/D conversion such as sampling.

The communication unit 222 is configured to include a communication interface for connecting the optical signal receiving unit 22 to an external device. The communication unit 222 communicates with an external device through wired or wireless connection. The external device is communicably connected to, for example, a computer operated by a user and accepts the user's operation on the optical signal receiving unit 22.

The storage unit 223 is configured using a computer readable storage medium device such as a magnetic hard disk device or a semiconductor storage device. The storage unit 223 stores various types of information on the optical signal receiving unit 22.

The signal receiving unit 224 receives an optical signal. The signal transmission unit 225 transmits the optical signal after A/D conversion received by the signal receiving unit 224.

### <State Learning Unit 23>

The state learning unit 23 receives the change content information and the optical signal. The state learning unit 23 uses the received change content information and optical signal to perform learning of an estimation model. The estimation model is a mathematical model for estimating the difference between an optical signal to be estimated and an optical signal in the optical branching unit 12 with respect to object characteristics. The object characteristics are predetermined characteristics of the optical signal.

That is, the estimation model is a mathematical model for estimating how the object characteristics of the optical signal to be estimated have changed from the object characteristics of the optical signal in the optical branching unit 12.

The object characteristics are, for example, an optical signal-to-noise ratio (OSNR) and polarization mode dispersion. Hereinafter, the communication system 100 will be described taking as an example a case where the object characteristics are an optical signal-to-noise ratio and polarization mode dispersion.

The estimation model may be a mathematical model represented in any way insofar as it is a mathematical model that can be updated through learning. The estimation model is represented by, for example, a neural network. The parameters of the neural network are appropriately adjusted on the basis of the value of the objective function (that is, loss). The parameters of the neural network are the parameters of the mathematical model it represents.

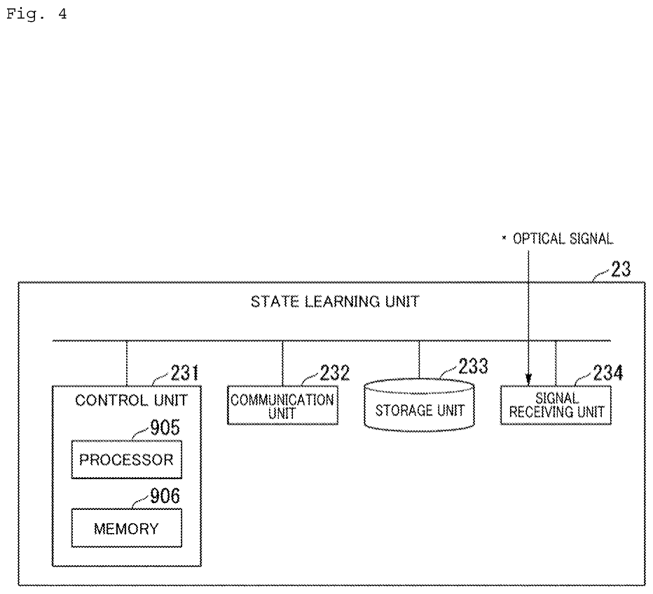

FIG. 4 is a diagram illustrating an example of a hardware configuration of the state learning unit 23 in the embodiment. The state learning unit 23 includes a control unit 231 including a processor 905 such as a CPU connected through a bus and a memory 906, and executes a program. The state learning unit 23 functions as a device including the control unit 231, a communication unit 232, the storage unit 233, and a signal receiving unit 234 by executing a program.

More specifically, the processor 905 reads out a program stored in the storage unit 233 and causes the memory 906 to store the readout program. By the processor 905 executing the program stored in the memory 906, the state learning unit 23 functions as a device including the control unit 231, the communication unit 232, the storage unit 233, and the signal receiving unit 234.

The control unit 231 controls operations of various functional units included in the state learning unit 23. The control unit 231 records, for example, various types of information in the storage unit 233. The control unit 231 executes, for example, an estimation model. The control unit 231 trains, for example, the estimation model.

The communication unit 232 is configured to include a communication interface for connecting the state learning unit 23 to an external device. The communication unit 232 communicates with an external device through wired or wireless connection. The external device is, for example, the emulation unit 21. The communication unit 232 acquires change content information through communication with the emulation unit 21. In addition, the communication unit 232 may be communicably connected to a computer operated by a user and may accept the user's operation on the state learning unit 23.

The storage unit 233 is configured using a computer readable storage medium device such as a magnetic hard disk device or a semiconductor storage device. The storage unit 233 stores various types of information on the state learning unit 23. The storage unit 233 stores, for example, the change content information. The storage unit 233 stores, for example, the estimation model in advance. Meanwhile, storing a mathematical model means storing values or computer programs for representing the mathematical model. The storage unit 233 stores, for example, the values of parameters after updating the estimation model. The storage unit 233 stores, for example, the trained estimation model. The trained estimation model means an estimation model at a point in time when a learning termination condition is satisfied.

The signal receiving unit 234 receives an optical signal. The signal receiving unit 234 receives, for example, the signal output by the optical signal receiving unit 22. Meanwhile, the optical signal receiving unit 22 may be included in the state learning unit 23, and in such a case, the signal receiving unit 234 receives the optical signal output by the emulation unit 21.

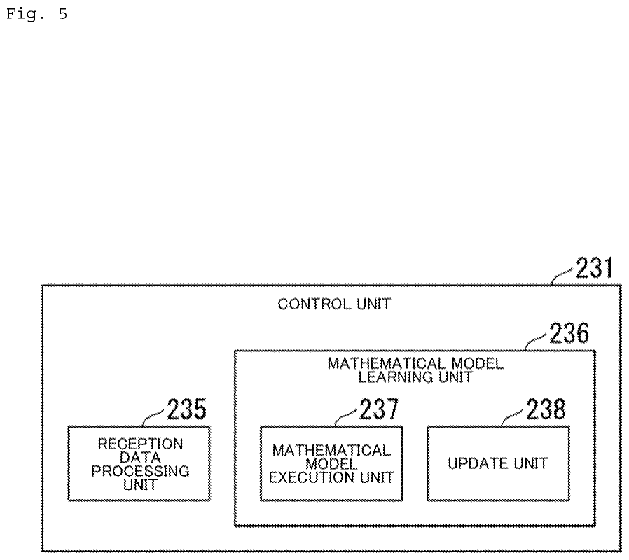

FIG. 5 is a diagram illustrating an example of a configuration of the control unit 231 included in the state learning unit 23 in the embodiment. The control unit 231 includes a reception data processing unit 235 and a mathematical model learning unit 236.

The reception data processing unit 235 acquires the change content information acquired by the communication unit 232 and acquires the optical signal received by the signal receiving unit 234. The reception data processing unit 235 executes an object characteristic acquisition process on the acquired optical signal. The object characteristic acquisition process is signal processing of acquiring information indicating object characteristics from the optical signal. Hereinafter, information indicating object characteristics is referred to as object characteristic information.

The object characteristic acquisition process is, for example, a process of executing Fourier transform for an optical signal and a process of acquiring an optical signal-to-noise ratio and polarization mode dispersion on the basis of a spectrogram obtained by the Fourier transform.

Meanwhile, in a case where the state learning unit 23 includes the optical signal receiving unit 22, the optical signal receiving unit 22 more specifically includes the reception data processing unit 235. In such a case, A/D conversion is also executed in the object characteristic acquisition process.

The reception data processing unit 235 also executes a training data generation process. The training data generation process is a process of generating data including the object characteristic information and the change content information using the object characteristic information obtained in the object characteristic acquisition process and the change content information. The data generated in this way is used as training data for learning of the estimation model. Therefore, the training data generation process is a process of generating training data including the object characteristics and the change content information using the object characteristic information and the change content information.

The mathematical model learning unit 236 trains the estimation model using the training data. More specifically, the mathematical model learning unit 236 first executes the estimation model on the object characteristic information included in the training data. Next, the mathematical model learning unit 236 updates the estimation model on the basis of the execution result of the estimation model and the change content information included in the training data so as to reduce the difference between the execution result of the estimation model and the change content information.

The estimation model estimates the difference between the optical signal having the object characteristics indicated by the object characteristic information included in the training data and the optical signal in the optical branching unit 12. Since the emulation unit 21 changes the optical signal of the optical branching unit 12 in the learning device 2. Therefore, as the accuracy of the estimation model becomes higher, the difference of estimation of the estimation model becomes closer to the change given to the optical signal of the optical branching unit 12 by the emulation unit 21.

Thus, the estimation model is a mathematical model for estimating the difference between the optical signal to be estimated and the optical signal in the optical branching unit 12 on the basis of the object characteristic information indicating the object characteristics of the optical signal to be estimated.

The mathematical model learning unit 236 includes a mathematical model execution unit 237 and an update unit 238. The mathematical model execution unit 237 executes the estimation model on the object characteristic information included in the training data. The mathematical model execution unit 237 estimates the difference between the optical signal having the object characteristics included in the training data and the optical signal in the optical branching unit 12 by executing the estimation model.

The update unit 238 updates the estimation model on the basis of the estimation result of the mathematical model execution unit 237 and the change content information included in the training data so as to reduce the difference between the execution result of the estimation model and the change content information.

The estimation model is updated by the learning device 2 at each predetermined timing with the model being updated until the learning termination condition is satisfied. Hereinafter, the predetermined timing is referred to as a learning timing.

The learning timing is, for example, a periodic timing occurring at every period determined in advance. That is, the learning device 2 performs a series of processes of updating the estimation model at each learning timing from the start of learning until the learning termination condition is satisfied. Therefore, the estimation model which is updated at least at the second and subsequent learning timings is a trained estimation model for which the learning termination condition is satisfied at the immediately preceding learning timing.

FIG. 1 will be described again. The reception-side optical node device 3 receives the optical signal branched by the optical branching unit 12. More specifically, the reception-side optical node device 3 receives one of a plurality of optical signals branched by the optical branching unit 12, that is, an optical signal different from the optical signal that propagates to the learning device 2. The reception-side optical node device 3 includes an optical receiver 31 and an estimation unit 32.

### <Optical Receiver 31>

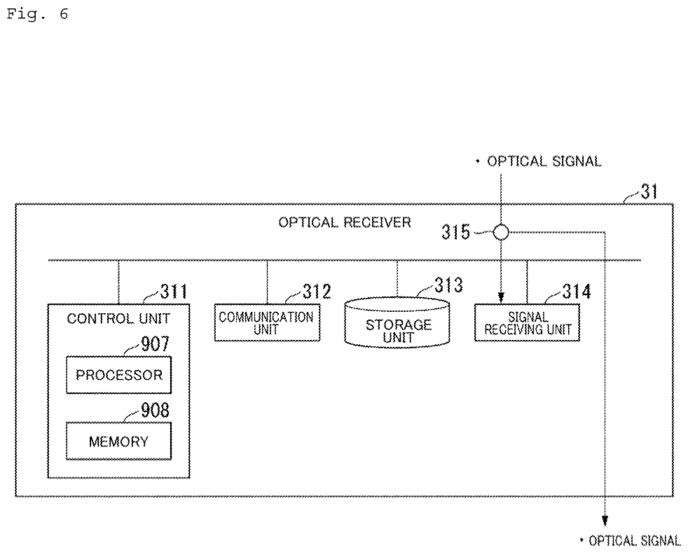

FIG. 6 is a diagram illustrating an example of a hardware configuration of the optical receiver 31 in the embodiment. The optical receiver 31 includes a control unit 311 including a processor 907 such as a CPU connected through a bus and a memory 908, and executes a program. The optical receiver 31 functions as a device including the control unit 311, a communication unit 312, a storage unit 313, a signal receiving unit 314, and an optical branching unit 315 by executing a program.

More specifically, the processor 907 reads out the program stored in the storage unit 313 and causes the memory 908 to store the readout program. By the processor 907 executing the program stored in the memory 908, the optical receiver 31 functions as a device including the control unit 311, the communication unit 312, the storage unit 313, the signal receiving unit 314, and the optical branching unit 315.

The control unit 311 controls operations of various functional units included in the optical receiver 31. The control unit 311 records, for example, various types of information in the storage unit 313. The control unit 311 executes the object characteristic acquisition process on the optical signal received by the signal receiving unit 314 of which the details will be described later. The control unit 311 acquires information indicating the object characteristics of the optical signal received by the signal receiving unit 314 by executing the object characteristic acquisition process. Hereinafter, the object characteristic information indicating the object characteristics of the optical signal received by the optical receiver 31 is referred to as estimation object characteristic information.

The communication unit 312 is configured to include a communication interface for connecting the optical receiver 31 to an external device. The communication unit 312 communicates with an external device through wired or wireless connection. The external device is, for example, the estimation unit 32.

The communication unit 312 transmits the estimation object characteristic information acquired by the control unit 311 to the estimation unit 32 through communication with the estimation unit 32. In addition, the communication unit 312 may be communicably connected to a computer operated by a user and may accept the user's operation on the optical receiver 31.

The storage unit 313 is configured using a computer readable storage medium device such as a magnetic hard disk device or a semiconductor storage device. The storage unit 313 stores various types of information on the optical receiver 31. The storage unit 313 stores, for example, the estimation object characteristic information.

The signal receiving unit 314 receives an optical signal. The signal receiving unit 314 receives the signal output by the optical transmitter 11. The optical signal received by the signal receiving unit 314 is a portion of the signal output by the optical transmitter 11, that is, an optical signal branched by the optical branching unit 315. The optical branching unit 315 branches the optical signal. The optical branching unit 315 is, for example, an optical coupler. One of the optical signals branched by the optical branching unit 315 is incident on the signal receiving unit 314, and the other one is emitted from the optical receiver 31 and propagates toward a predetermined propagation destination.

### <Estimation Unit 32>

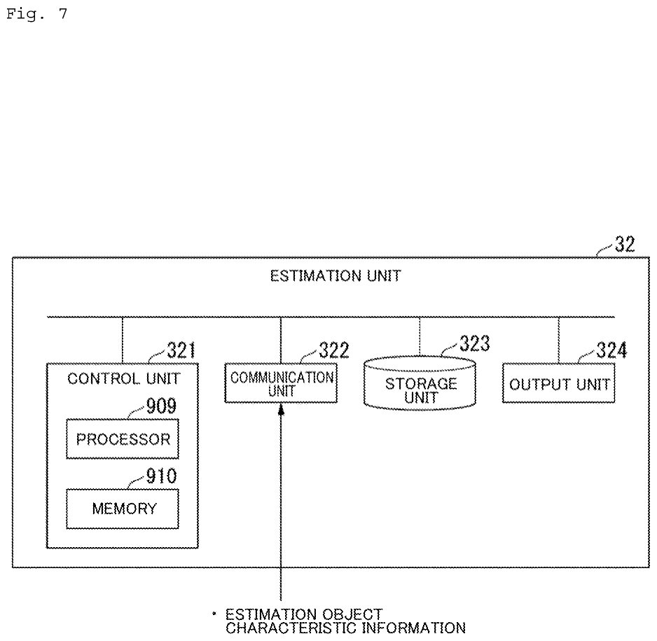

FIG. 7 is a diagram illustrating an example of a hardware configuration of the estimation unit 32 in the embodiment. The estimation unit 32 includes a control unit 321 including a processor 909 such as a CPU connected through a bus and a memory 910, and executes a program. The estimation unit 32 functions as a device including the control unit 321, a communication unit 322, and a storage unit 323 by executing a program.

More specifically, the processor 909 reads out the program stored in the storage unit 323 and causes the memory 910 to store the readout program. By the processor 909 executing the program stored in the memory 910, the estimation unit 32 functions as a device including the control unit 321, the communication unit 322, and the storage unit 323.

The control unit 321 controls operations of various functional units included in the estimation unit 32. The control unit 321 records, for example, various types of information in the storage unit 323. The control unit 321 executes, for example, the trained estimation model obtained by the learning device 2.

The communication unit 322 is configured to include a communication interface for connecting the estimation unit 32 to an external device. The communication unit 322 communicates with an external device through wired or wireless connection. The external device is, for example, the state learning unit 23. The communication unit 322 acquires the trained estimation model through communication with the state learning unit 23. In addition, the communication unit 322 may be communicably connected to a computer operated by a user and may accept the user's operation on the estimation unit 32.

The storage unit 323 is configured using a computer readable storage medium device such as a magnetic hard disk device or a semiconductor storage device. The storage unit 323 stores various types of information on the estimation unit 32. The storage unit 323 stores, for example, the trained estimation model in advance.

An output unit 324 outputs various types of information. The output unit 324 is configured to include a display device such as, for example, a cathode ray tube (CRT) display, a liquid crystal display, or an organic electro-luminescence (EL) display. The output unit 324 may be configured to as an interface connecting these display devices to the estimation unit 32. The output unit 324 outputs, for example, the result of execution of the trained estimation model by the control unit 321 using an output method determined in advance such as display.

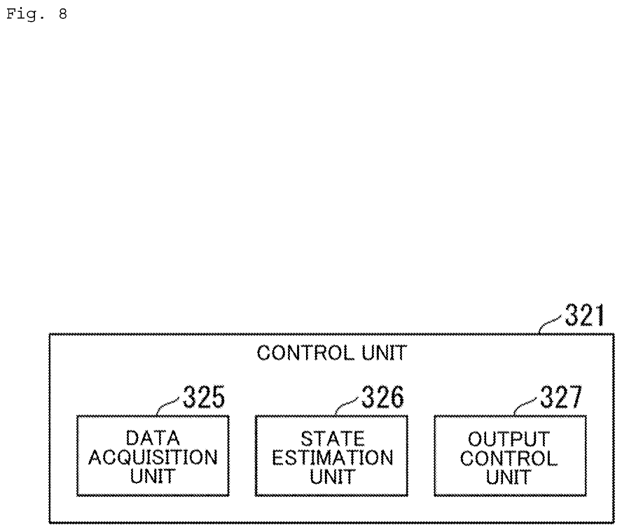

FIG. 8 is a diagram illustrating an example of a configuration of the control unit 321 included in the estimation unit 32 in the embodiment. The control unit 321 includes a data acquisition unit 325, a state the estimation unit 326, and an output control unit 327. The data acquisition unit 325 acquires the estimation object characteristic information received by the communication unit 322.

The state the estimation unit 326 executes the trained estimation model on the estimation object characteristic information acquired by the data acquisition unit 325. By executing the trained estimation model on the estimation object characteristic information, the state the estimation unit 326 acquires information indicating the difference between the optical signal having the object characteristics indicated by the estimation object characteristic information and the optical signal in the optical branching unit 12. Hereinafter, the information indicating the difference between the optical signal having the object characteristics indicated by the estimation object characteristic information and the optical signal in the optical branching unit 12 is referred to as estimation result information.

The output control unit 327 controls the operation of the output unit 324. The output control unit 327 controls the operation of the output unit 324 and causes the output unit 324 to output the estimation result information.

The communication unit 322 outputs the estimation result information to a predetermined output destination. The predetermined output destination is, for example, a device that determines whether one or both of the optical transmitter 11 and the optical fiber 4 are normal on the basis of the estimation result information (hereinafter referred to as an “abnormality determination device”).

The result of execution of the trained estimation model output by the output unit 324 is specifically the estimation result information.

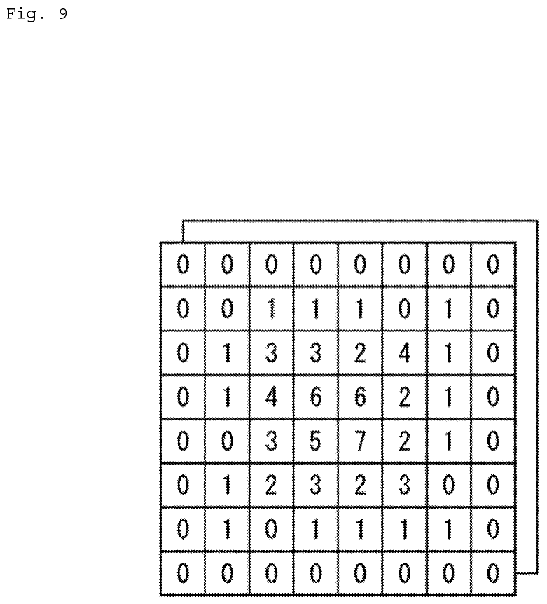

FIG. 9 is a diagram illustrating an example of object characteristic information included in training data in the embodiment. The object characteristic information is, for example, constellation data for each of two polarized waves orthogonal to each other shown in FIG. 9. The two polarized waves orthogonal to each other are, for example, an X polarized wave and a Y polarized wave.

### <Example of Flow of Processing>

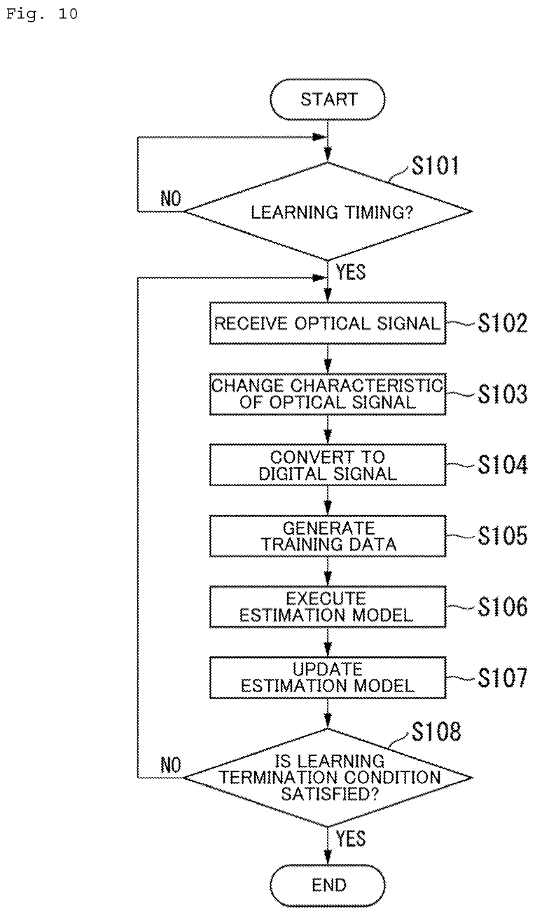

FIG. 10 is a flowchart illustrating an example of a flow of processing executed by the learning device 2 in the embodiment. The learning device 2 determines whether it is a learning timing (step S101). The determination of whether it is a learning timing may be performed by any of the functional units included in the learning device 2, but is performed by, for example, the control unit 211 included in the emulation unit 21. The determination of whether it is a learning timing may be performed by the control unit 231 included in the state learning unit 23.

In a case where it is not a learning timing (step S101: NO), the process of step S101 is repeated. On the other hand, in a case where it is a learning timing (step S101: YES), the learning device 2 receives the optical signal branched by the optical branching unit 12 (step S102). More specifically, the emulation unit 21 receives the optical signal branched by the optical branching unit 12. Next, the characteristics of the optical signal received by the emulation unit 21 are changed (step S103). Next, the optical signal receiving unit 22 converts the optical signal output by the emulation unit 21 into a digital signal and outputs the result (step S104).

Next, the reception data processing unit 235 generates training data including object characteristic information indicating the object characteristics of the optical signal output by the optical signal receiving unit 22 and change content information which is information indicating the content of the change in step S103 (step S105). Next, the mathematical model execution unit 237 executes the estimation model on the object characteristic information included in the training data obtained in step S105 (step S106).

By executing the estimation model, the mathematical model execution unit 237 obtains, as an estimation result, the difference between the optical signal having the object characteristics indicated by the object characteristic information included in the training data and the optical signal in the optical branching unit 12. Next, the update unit 238 updates the estimation model so as to reduce the difference between the difference estimated in step S106 and the change content information included in the training data (step S107).

Next, the update unit 238 determines whether the learning termination condition is satisfied (step S108). In a case where the learning termination condition is satisfied (step S108: YES), the process ends. The estimation model at a point in time when the learning termination condition is satisfied is a trained estimation model. The trained estimation model is used by the estimation unit 32. After the process ends, the process of step S101 is started again.

On the other hand, in a case where the learning termination condition is not satisfied (step S108: NO), the process returns to step S102.

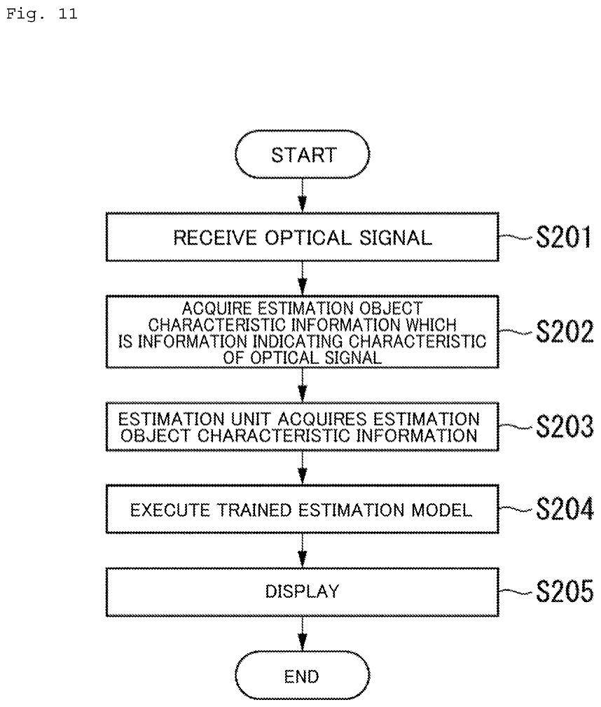

FIG. 11 is a flowchart illustrating an example of a flow of processing executed by the reception-side optical node device 3 in the embodiment. The optical receiver 31 receives one of the optical signals branched by the optical branching unit 12, that is, one optical signal other than the optical signal propagated to the learning device 2 (step S201). More specifically, the signal receiving unit 314 receives one of the optical signals branched by the optical branching unit 12, that is, one optical signal other than the optical signal propagated to the learning device 2.

Next, the control unit 311 included in the optical receiver 31 executes the object characteristic acquisition process on the optical signal acquired in step S201 (step S202). The control unit 311 acquires estimation object characteristic information indicating the object characteristics of the optical signal acquired in step S201 by executing the object characteristic acquisition process. Next, the estimation unit 32 acquires the estimation object characteristic information acquired in step S202 (step S203). More specifically, the data acquisition unit 325 acquires the estimation object characteristic information acquired in step S202 through the communication unit 322.

Next, the state the estimation unit 326 executes the trained estimation model obtained by the learning device 2 for the estimation object characteristic information (step S204). In step S204, the state the estimation unit 326 acquires estimation result information. Next, the output unit 324 displays the estimation result information (step S205).

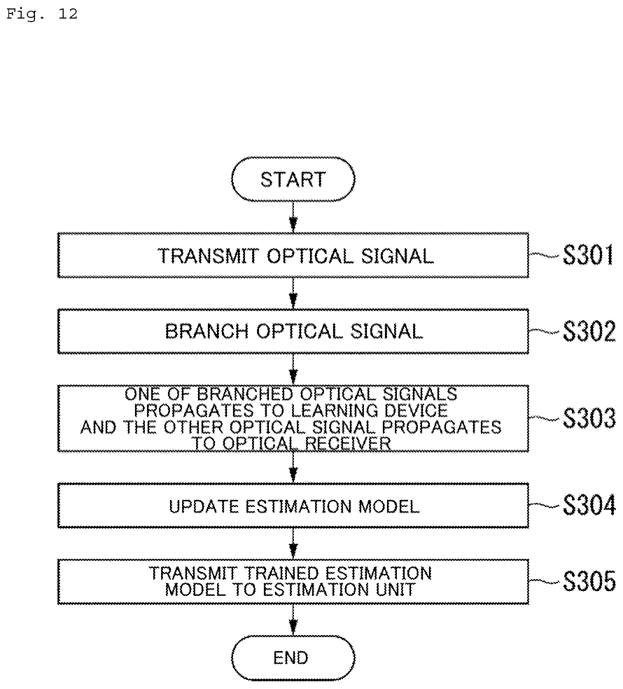

FIG. 12 is a first flowchart illustrating an example of a flow of processing executed by the communication system 100 in the embodiment. More specifically, FIG. 12 is a flowchart illustrating an example of a flow of processing executed by the communication system 100 at a learning timing.

The optical transmitter 11 transmits the optical signal (step S301). Next, the optical signal is branched by the optical branching unit 12 (step S302). One of the optical signals branched by the optical branching unit 12 propagates to the learning device 2, and the other branched optical signal propagates to the optical receiver 31. (Step S303). The learning device 2 uses the propagated optical signal to update the estimation model until the learning termination condition is satisfied (step S304). The learning device 2 transmits the obtained trained estimation model to the estimation unit 32 through the communication unit 232 (step S305). Meanwhile, in step S304, for example, the processes of steps S102 to S108 are executed.

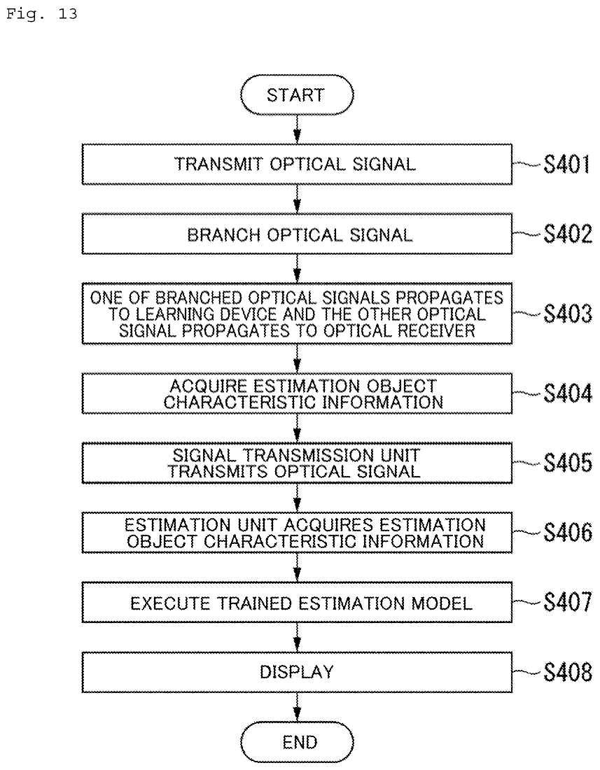

FIG. 13 is a second flowchart illustrating an example of a flow of processing executed by the communication system 100 in the embodiment. More specifically, FIG. 13 is a flowchart illustrating an example of a flow of processing executed by the communication system 100 at a timing which is not a learning timing.

The optical transmitter 11 transmits the optical signal (step S401). Next, the optical signal is branched by the optical branching unit 12 (step S402). One of the optical signals branched by the optical branching unit 12 propagates to the learning device 2, and the other branched optical signal propagates to the optical receiver 31. (Step S403). The optical signal receiving unit 22 executes the object characteristic acquisition process on the optical signal propagated to the optical receiver 31, and acquires the estimation object characteristic information (step S404).

Next, the signal transmission unit 225 transmits the optical signal propagated to the optical receiver 31 in step S403 (step S405). Next, the estimation unit 32 acquires the estimation object characteristic information acquired in step S404 (step S406).

Next, the estimation unit 32 executes the trained estimation model obtained by the learning device 2 at a learning timing for the estimation object characteristic information (step S407). In step S407, the state the estimation unit 326 acquires estimation result information. Next, the output unit 324 displays the estimation result information (step S408).

Meanwhile, the process of step S405 does not necessarily have to be executed after the process of step S404, and may be executed at any timing after the process of step S403.

### <Relationships and Roles Between Learning Device 2, Optical Branching Unit 12, and Estimation Model>

Communication systems, not limited to the communication system 100, are often assumed to be used for a long period of time, and deteriorate over time during the long period of use.

Therefore, in order to manage the communication system, it is desirable to estimate the state of the communication system in consideration of the influence of deterioration over time. The state of the communication system is, for example, the state of the optical transmitter 11. In order to manage a system that incorporates such changes over time, it is desirable to change the criteria for detection and rules for determining the state of the system in accordance with changes in the system over time. Consequently, the communication system 100 includes the optical branching unit 12 and the learning device 2.

As described above, the learning device 2 changes the optical signal branched by the optical branching unit 12, and learns the state of change in the optical signal in the optical branching unit 12 at a learning timing. The change is triggered by the emulation unit 21.

The roles of the optical branching unit 12 and the emulation unit 21 are described in order. In infrastructure equipment such as communication systems, it is difficult to install and remove devices after service has started. The start of service is specifically the start of communication. Therefore, it is desirable that the learning device 2 be included in the communication system 100 without the need to be removed from the communication system 100.

Consequently, the communication system 100 includes the optical branching unit 12. Since the communication system 100 includes the optical branching unit 12, the optical signal transmitted by the optical transmitter 11 is branched by the optical branching unit 12, thereby realizing communication and transmission of the optical signal to the learning device 2. As a result, in the communication system 100, it is possible to realize communication as well as to update the mathematical model in accordance with changes in the optical transmitter 11 over time.

Next, the role of the emulation unit 21 will be described. The change in the optical signal caused by the emulation unit 21 is equivalent to pseudo-causing a change that can occur in the optical signal due to an event occurring within the communication system 100. Therefore, the accuracy of estimation performed by the estimation model is enhanced through learning using the optical signal of which the characteristics have been changed by the emulation unit 21.

Incidentally, the object characteristics change mainly due to two factors with different time scales. One is a change in the state of the communication system 100 over time. Hereinafter, the change in the state of the communication system 100 over time is referred to as a first factor. The other is randomness included in Heisenberg's uncertainty principle and natural phenomena represented by noise. Hereinafter, randomness included in Heisenberg's uncertainty principle and natural phenomena represented by noise is referred to as a second factor.

The change due to the first factor has a longer time scale than the change due to the second factor. In the management of a system which is assumed to be used for a long period of time, such as the communication system 100, it is necessary to consider these two changes in order to ascertain the state of the communication system 100.

Since the learning device 2 receives the optical signal branched from the optical branching unit 12, the estimation model can be updated even while the communication system 100 is performing communication. If the change in the first factor is to be ignored, a mathematical model for estimating the state of the communication system using the object characteristics of the input optical signal need only be obtained once through machine learning. The mathematical model obtained in this way can estimate the state of the communication system with a high level of accuracy if the change in the communication system due to the first factor can be ignored.

However, in a case where there is a change in the communication system due to the first factor, the accuracy of estimation will decrease with the change in the communication system over time unless learning is performed in accordance with the change in the communication system over time.

As described above, the learning device 2 of the communication system 100 can update the estimation model even while the communication system 100 is performing communication. Therefore, the learning device 2 can execute learning not only once, but also multiple times in accordance with changes in the communication system 100 over time. Therefore, the learning device 2 can obtain a mathematical model for estimating the state of the communication system 100 under the condition that the first factor and the second factor are present.

More specifically, description will be given of how learning is possible under the condition that the first factor and the second factor are present. As described above, the emulation unit 21 changes the optical signal branched by the optical branching unit 12. That is, the emulation unit 21 generates an optical signal obtained by changing the optical signal branched by the optical branching unit 12.

In a case where there is a change in the state of the communication system 100 over time, the optical signal branched by the optical branching unit 12 changes in correlation with the change. Therefore, the emulation unit 21 generates an optical signal containing information on a change in the state of the communication system 100 over time.

On the other hand, the emulation unit 21 simulates the change that can occur in the optical signal due to an event occurring within the communication system 100 as described above. This pseudo change mimics the change due to the second factor. That is, the emulation unit 21 imparts a change in the optical signal caused by randomness included in natural phenomena to the optical signal received by the learning device 2.

In this way, the emulation unit 21 generates an optical signal containing information on a change caused by the first factor and information on a change caused by the second factor. Since the object characteristics of the optical signal generated by the emulation unit 21 are used for learning as part of the training data, the learning device 2 can perform learning under the condition that the first factor and the second factor are present.

Learning performed by the learning device 2 is executed on the estimation model. As described above, the object characteristics of the optical signal generated by the emulation unit 21 are used for learning as part of the training data. Therefore, the estimation model is a mathematical model for estimating the difference between the optical signal to be estimated for the object characteristics and the optical signal in the optical branching unit 12, where the difference is information indicating the result of estimation of the state of the communication system 100. That is, the estimation model is a mathematical model for estimating the state of the communication system 100 on the basis of the object characteristics of the input optical signal.

As described above, the trained mathematical model obtained by the learning device 2 is used by the estimation unit 32 to estimate the state of the communication system 100. The trained estimation model is further updated at a learning timing to generate a new trained estimation model. Since the estimation unit 32 uses the estimation model obtained by the learning device 2, the trained estimation model used by the estimation unit 32 is updated to the trained estimation model at a point in time when the learning termination condition is satisfied each time the learning termination condition is satisfied. Therefore, the communication system 100 enables the management of the communication system considering not only the second factor but also the first factor.

### <Example of how Estimation Result Information is Used>

Here, an example of how the estimation result information is used will be described. As described above, the estimation result information is information indicating the difference between the optical signal having the object characteristics indicated by the estimation object characteristic information and the optical signal in the optical branching unit 12. As described above, the difference is information indicating the result of estimation of the state of the communication system 100. Therefore, the estimation result information is an example of information indicating the state of the communication system 100.

The difference is caused by the transmission loss occurring due to the transmission of the optical fiber 4 and the abnormality of the optical transmitter 11. If there is no abnormality in the optical transmitter 11, the difference is due to the transmission loss. Therefore, if the difference exceeds a predetermined range, this indicates that there is a possibility of the optical transmitter 11 being abnormal. Therefore, once the estimation result information is obtained, for example, the above-described abnormality determination device can determine whether an abnormality has occurred in the optical transmitter 11. In addition, by displaying the estimation result information on the output unit 324, a user can also determine whether an abnormality has occurred in the optical transmitter 11.

In addition, an abnormality of the optical transmitter 11 may occur suddenly. Thus, if the difference is acquired at a learning timing in advance, for example, the above-described abnormality determination device or the user can determine whether an abnormality has occurred in the optical transmitter 11 when the difference changes suddenly.

Since the communication system 100 acquires the estimation result information and outputs the acquired estimation result information, it is possible to reduce the burden required to suppress the occurrence of communication failures.

The communication system 100 of the embodiment configured in this way includes the optical branching unit 12 that branches the optical signal transmitted by the optical transmitter 11, and the learning device 2 that updates the estimation model on the basis of the optical signal branched by the optical branching unit 12. Therefore, the optical signal transmitted from the optical transmitter 11 is branched by the optical branching unit 12 and propagates to the learning device 2 and the optical receiver 31.

As a result, the communication system 100 can update the mathematical model (that is, the estimation model) for estimating the state of the communication system 100 while realizing the transmission of the optical signal from the optical transmitter 11 to the optical receiver 31. Therefore, the communication system 100 can reduce the burden required to manage a host system.

### Modification Example

Meanwhile, the communication system 100 does not necessarily need to have only one optical transmitter 11 and one reception-side optical node device 3. The communication system 100 may include a plurality of optical transmitters 11 and a plurality of reception-side optical node devices 3. Hereinafter, the communication system 100 including a plurality of optical transmitters 11 and a plurality of reception-side optical node devices 3 is referred to as a communication system 100a.

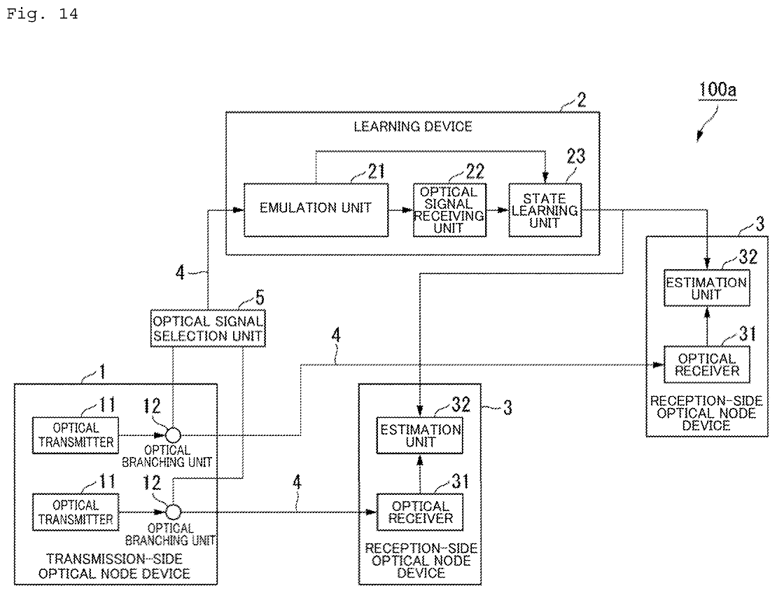

FIG. 14 is a diagram illustrating an example of a configuration of a communication system 100a in a modification example. Hereinafter, the same reference numerals and signs as in FIG. 1 are assigned to the same components as those provided in the communication system 100, and the description thereof is omitted.

The communication system 100a differs from the communication system 100 in that it includes not one but a plurality of sets of optical transmitters 11, optical branching units 12, and reception-side optical node devices 3. In addition, the communication system 100a differs from the communication system 100 in that it includes an optical signal selection unit 5. The optical signal selection unit 5 determines which one of a plurality of optical branching units 12 included in the communication system 100a should transmit the optical signal to the learning device 2, and propagates only the determined optical signal to the learning device 2. Therefore, the optical signal selection unit 5 is, for example, a functional unit including an optical switch that switches an optical signal to be propagated to the learning device 2 in accordance with a predetermined rule. The predetermined rule is, for example, a rule of switching an optical signal to be propagated to the learning device 2 in an order determined in advance at a period determined in advance.

In the communication system 100a, each of the estimation units 32 receives the updated estimation model transmitted by the learning device 2. In the communication system 100a, each of the estimation units 32 uses the received updated estimation model to estimate the state of the communication system 100a.

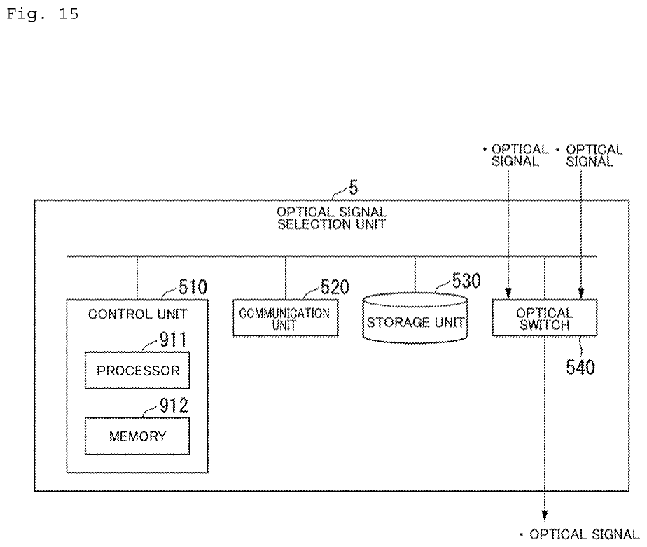

FIG. 15 is a diagram illustrating an example of a hardware configuration of the optical signal selection unit 5 in the modification example. The optical signal selection unit 5 includes a control unit 510 including a processor 911 such as a CPU connected through a bus and a memory 912, and executes a program. The optical signal selection unit 5 functions as a device including the control unit 510, a communication unit 520, a storage unit 530, and an optical switch 540 by executing a program.

More specifically, the processor 911 reads out the program stored in the storage unit 530 and causes the memory 912 to store the readout program. By the processor 911 executing the program stored in the memory 912, the optical signal selection unit 5 functions as a device including the control unit 510, the communication unit 520, the storage unit 530, and the optical switch 540.

The control unit 510 controls operations of various functional units included in the optical signal selection unit 5. The control unit 510 records, for example, various types of information in the storage unit 530. The control unit 510 executes an optical signal determination process. The optical signal determination process is a process of determining which one of a plurality of optical branching units 12 included in the communication system 100a should transmit the optical signal to the learning device 2 in accordance with a predetermined rule. The control unit 510 controls the operation of the optical switch 540 to transmit only the determined optical signal to the learning device 2.

The communication unit 520 is configured to include a communication interface for connecting the optical signal selection unit 5 to an external device. The communication unit 520 may be communicably connected to, for example, a computer operated by a user and may accept the user's operation on the optical receiver 31.

The storage unit 530 is configured using a computer readable storage medium device such as a magnetic hard disk device or a semiconductor storage device. The storage unit 530 stores various types of information on the optical signal selection unit 5. The storage unit 530 stores, for example, a history of the results of the optical signal determination process.

The optical switch 540 receives optical signals transmitted from the plurality of optical branching units 12 included in the communication system 100a. The optical switch 540 transmits one of a plurality of received optical signals, which is determined to be transmitted toward the learning device 2 through the optical signal determination process, to the learning device 2 under control performed by the control unit 510. The optical switch 540 may be, for example, a mechanical optical switch or may be a micro electro mechanical systems (MEMS) optical switch.

Meanwhile, the optical signal selection unit 5 may be included in the transmission-side optical node device 1, may be included in the learning device 2, or may be included in both the transmission-side optical node device 1 and the learning device 2.

Meanwhile, the optical branching unit 12 does not necessarily have to be included in the transmission-side optical node device 1, and may be mounted in a different housing from the transmission-side optical node device 1 and the optical branching unit 12.

Meanwhile, the transmission-side optical node device 1 and the learning device 2 do not necessarily have to be mounted in different housings, and may be mounted in the same housing. Meanwhile, the transmission-side optical node device 1, the learning device 2, and the reception-side optical node device 3 do not necessarily have to be mounted in different housings, and may be mounted in the same housing.

Meanwhile, the learning device 2 is an example of a learning unit.

Meanwhile, each of the learning device 2 and the estimation unit 32 may be implemented using a plurality of information processing devices communicably connected to each other through a network. Meanwhile, all or some of the functions of the learning device 2 and the estimation unit 32 may be realized using hardware such as an application specific integrated circuit (ASIC), a programmable logic device (PLD), or a field programmable gate array (FPGA). The program may be recorded on a computer-readable recording medium. The computer-readable recording medium is, for example, a flexible disk, a magneto-optical disk, a ROM, a portable medium such as a CD-ROM, or a storage device such as a hard disk built into a computer system. The program may be transmitted through an electric communication line.

Although the embodiments of the present invention have been described in detail with reference to the drawings, specific configurations are not limited to these embodiments, and designs and the like within a range that does not deviating from the gist of the present invention are also included.

### REFERENCE SIGNS LIST

100, 100a Communication system
1 Transmission-side optical node device
2 Learning device
3 Reception-side optical node device
4 Optical fiber
5 Optical signal selection unit
11 Optical transmitter
12 Optical branching unit
21 Emulation unit
22 Optical signal receiving unit
23 State learning unit
31 Optical receiver
32 Estimation unit
211 Control unit
212 Communication unit
213 Storage unit
214 Optical characteristic change unit
15 Optical spectrum analyzer
216 Wavelength dispersion generator
217 Polarization mode dispersion generator
218 ASE light source
221 Control unit
222 Communication unit
223 Storage unit
224 Signal receiving unit
225 Signal transmission unit
231 Control unit
232 Communication unit
233 Storage unit
234 Signal receiving unit
235 Reception data processing unit
236 Mathematical model learning unit
237 Mathematical model execution unit
238 Update unit
311 Control unit
312 Communication unit
313 Storage unit
314 Signal receiving unit
315 Optical branching unit
321 Control unit
322 Communication unit
323 Storage unit
324 Output unit
325 Data acquisition unit
326 State estimation unit
327 Output control unit
510 Control unit
520 Communication unit
530 Storage unit
540 Optical switch
901, 903, 905, 907, 909, 911 Processor
902, 904, 906, 908, 910, 912 Memory

1. A communication system comprising:
a processor; and
a storage medium having computer program instructions stored thereon, when executed by the processor, perform to:
branch an optical signal transmitted by a transmitter that transmits an optical signal; and
update an estimation model, which is a mathematical model for estimating a state of a host system on the basis of information indicating an object characteristic that is a predetermined characteristic of the optical signal, on the basis of one of optical signals branched by the branching unit.

2. The communication system according to claim 1, wherein the computer program instructions further perform a series of processes of updating the estimation model from start of learning until a predetermined termination condition related to learning is satisfied at each predetermined timing.

3. The communication system according to claim 2, wherein the computer program instructions further perform to estimate the state of the host system using the estimation model on the basis of another object characteristic of the optical signal.

4. The communication system according to claim 3, wherein the estimation model is updated to the estimation model at a point in time when the termination condition is satisfied each time the termination condition is satisfied.

5. The communication system according to claim 1, wherein the object characteristic used for learning of the estimation model is an object characteristic of an optical signal obtained by changing the optical signal.

6. The communication system according to claim 1, wherein the object characteristic is an optical signal-to-noise ratio (OSNR) and polarization mode dispersion.

7. A communication method which is executed by a communication system including a branching unit configured to branch an optical signal transmitted by a transmitter that transmits an optical signal, and a learning unit configured to update an estimation model, which is a mathematical model for estimating a state of a host system on the basis of an object characteristic that is a predetermined characteristic of the optical signal, on the basis of one of optical signals branched by the branching unit, the method comprising
a learning step of updating the estimation model on the basis of one of optical signals branched by the branching unit.

8. A non-transitory computer-readable medium having computer-executable instructions that, upon execution of the instructions by a processor of a computer, cause the computer to function as the communication system according to claim 1.
